(19) United States
(12) Patent Application Publication
(10) Pub. No.: US 2022/0072921 A1
(43) Pub. Date: Mar. 10, 2022

(54) HYBRID TRACK AND WHEEL SYSTEM, TRACK, WHEEL ASSEMBLIES AND VEHICLE

(71) Applicant: Steven Ostrowski, Ontario (CA)

(72) Inventor: Steven Ostrowski, Ontario (CA)

(21) Appl. No.: 17/468,355

(22) Filed: Sep. 7, 2021

Related U.S. Application Data
(60) Provisional application No. 63/075,233, filed on Sep. 7, 2020.

(51) Int. Cl. B60F 1/00; B60F 1/02; B60B 11/06

(52) U.S. Cl. CPC B60F 1/005; B60B 11/06; B60F 1/02

(57) ABSTRACT

A dual wheel assembly comprising a hub body that includes a central hub having a plurality of apertures to connect to bolts of a vehicle. The hub body includes a tire rim integrated with the central hub and having an outboard flange, an inboard flange and a drop center between the outboard flange and the inboard flange. The hub body includes a rail wheel integrated with at least one of the central hub and tire rim. The embodiments further include a triple wheel assembly and a vehicle with at least one of the dual wheel assembly and the triple wheel assembly.

### CROSS-REFERENCE TO RELATED APPLICATIONS

This application claims the benefit of U.S. Provisional Application No. 63/075,233, filed Sep. 7, 2020, which is incorporated herein by reference in its entirety.

### FIELD OF THE INVENTION

The present concept relates generally to the hybrid track and wheel system and, more particularly, relates to a rail transit concept that uses vehicles with wheels that can travel both on tracks and on normal pavement.

### BACKGROUND

Light rail transit systems (LRT) use vehicles which move exclusively on a track system which is laid onto the ground for the movement of people and/or other objects along the track. LRT vehicles are normally deployed in highly densely populated urban areas.

Buses on the other hand do not use a track system, but rather are able to move along existing roadways with other vehicles using rubber style tires. This form of public transportation is used in urban areas for the movement of people throughout urban areas along selected roadway routes.

Each of these people moving solutions has its advantages and disadvantages which are well-known to those skilled in the art. The current concept is a hybrid track and wheel system which combines the benefits of LRT, namely vehicles which travel on tracks together with the benefits of buses or vehicles that travel on pavement.

### SUMMARY

An aspect of the embodiments includes a dual wheel assembly comprising a hub body that includes a central hub having a plurality of apertures to connect to bolts; a tire rim having an outboard flange, an inboard flange and a drop center between the outboard flange and the inboard flange; and a rail wheel integrated with at least one of the central hub and tire rim.

In some embodiments, the rail wheel includes a vibration dampening ring connected between an inner hoop connected to the tire rim and an outer hoop configured to engage a rail track.

Another aspect of the embodiments includes a triple wheel assembly that includes a first hub body including a first central hub having a plurality of apertures to connect to bolts, and a first tire rim having an outboard flange, an inboard flange and a drop center between the outboard flange and the inboard flange. The triple wheel hub assembly includes a second hub body including a second central hub having a plurality of apertures to connect to bolts, and a second tire rim having an outboard flange, an inboard flange and a drop center between the outboard flange and the inboard flange; a rail wheel having a central disc having a plurality of apertures to connect to the bolts of the vehicle and an outer hoop affixed to a perimeter of the central disc.

A still further aspect of the embodiments includes a vehicle that includes a pair of front wheel assemblies and a pair of rear wheel assemblies and spacers. Each spacer configured to align a rear rail wheel with a front rail wheel of the vehicle.

A further aspect of the embodiments includes a vehicle configured to be controlled for autonomous platooning operation on the road and/or on the rail.

A further aspect of the embodiments includes a rail wheel control system that adjusts the rail wheel to maintain alignment with the rail track and to keep a distance offset from the tire and a side of the rail track.

### BRIEF DESCRIPTION OF THE DRAWINGS

With the intention of providing demonstration of characteristics of the device or method, or system, an example or examples are given below without restrictive character whatsoever with reference to the corresponding figures of preferred embodiments of the device, system and method as follows:

FIG. 1 is a schematic view of a hybrid track and wheel system with a small diameter wheel of a wheel assembly contacting an upper rolling surface of a track.

FIG. 2 is a schematic view of the hybrid track and wheel system with a larger diameter wheel of a wheel assembly contacting the road surface adjacent to the track.

FIG. 3 is a schematic view of the hybrid track and wheel system with the larger diameter of the wheel assembly wheel contacting the road surface adjacent to the track.

FIG. 4 is a schematic view of the hybrid track and wheel system with the small diameter wheel of the wheel assembly contacting upper rolling surface of the track.

FIG. 5 is a schematic view of the hybrid track and wheel system with the large diameter wheel of the wheel assembly beginning to make contact with a riser ramp of the track in an ascending or descending position.

FIG. 6 is a schematic view of the hybrid track and wheel system with the large diameter wheel of the wheel assembly making full contact with the riser ramp of the track at a raised position.

FIG. 7 is a schematic partial cross sectional and partial side elevational view of the dual wheel assembly positioned within the track such that the small diameter wheel makes contact with the upper rolling surface of the track and the wheel approaching the riser ramp shown in dashed lines.

FIG. 8 is a schematic partial cross-sectional side elevational view of the dual wheel assembly showing the large diameter wheel making contact with the riser ramp of the track in an ascending position.

FIG. 9 is a schematic partial cross-sectional side elevational view of the dual wheel assembly showing the large diameter wheel having reached the top of the riser ramp of the track in the raised position.

FIG. 10 is a top schematic plan view of a dual wheel assembly together with two tracks shown spaced apart and perpendicular to each other and the dual wheel assembly shown in three separate positions when it moves from the first track along an ark to a second track which is spaced away from and is perpendicular to the first track.

FIG. 11A illustrates a cross-sectional view of a dual wheel assembly on a rail track.

FIG. 11B illustrates a cross-sectional view of the dual wheel assembly on a surface of a road.

FIG. 12A illustrates a cross-sectional view of a rear triple wheel assembly on a rail track.

FIG. 12B illustrates a cross-sectional view of the rear triple wheel assembly on a surface of a road.

FIG. 13A illustrates a cross-sectional view of a dual wheel assembly on a surface of a road adjacent to a trough rail track of a hybrid track and wheel system.

FIG. 13B illustrates a cross-sectional view of the dual wheel assembly in a trough rail track of a hybrid track and wheel system.

FIG. 13C illustrates a vehicle with a pair of front dual wheel assemblies turning out of trough rail tracks.

FIG. 13D illustrates a vehicle with a pair of front dual wheel assemblies out of the trough rail tracks and on a road surface.

FIG. 14A illustrates a cross-sectional view of a rear triple wheel assembly on a surface of a road adjacent to a trough rail of a hybrid track and wheel system.

FIG. 14B illustrates a cross-sectional view of the rear triple wheel assembly in a trough rail track of a hybrid track and wheel system.

FIG. 15 illustrates a cross-sectional view of a front dual wheel assembly with a vibration compensation.

FIG. 16 illustrates a block diagram of a vehicle with a rail wheel control system.

FIG. 17 illustrates a block diagram of servo motors controlling rail wheels.

FIG. 18 illustrates a block diagram of an autonomous vehicle mode module.

FIG. 19 illustrates a block diagram of a vehicle control system.

FIG. 20 illustrates a flowchart of a method for adjusting a rail wheel.

FIG. 21 illustrates a flowchart of a method for platooning.

FIG. 22 illustrates a block diagram of a computing system.

FIG. 23 illustrates route sharing between a streetcar and vehicle with the vehicle driving on a surface of a road.

FIG. 24 illustrates route sharing between a streetcar and vehicle driving using a trough rail track.

FIG. 25A illustrates a vehicle driving on the road or street having a rail track in a recessed position in the road.

FIG. 25B illustrates a vehicle driving on the rail track in a raised position.

FIG. 26 illustrates a front view of a pair of rear triple wheel assemblies on a rail track.

FIG. 27 illustrates a plan view of a vehicle bed with a pair of front dual wheel assemblies and a pair of rear triple wheel assemblies aligned with the front dual wheel assemblies.

FIG. 28 illustrates a front view of a pair of rear triple wheel assemblies in a trough rail track.

FIG. 29 illustrates a plan view of a vehicle bed with a pair of front dual wheel assemblies and a pair of rear triple wheel assemblies aligned with the front dual wheel assemblies.

FIG. 30A illustrates a cross-sectional view of an inner hoop of the rail wheel.

FIG. 30B illustrates a cross-sectional view of a ring of the rail wheel.

FIG. 30C illustrates a cross-sectional view of an outer hoop of the rail wheel.

FIG. 30D illustrates a cross-sectional view of the rail wheel.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Referring now to FIGS. 1 through 6, the hybrid track and wheel system 100 includes a dual wheel assembly 102 configured to be mounted to an axle 104 which may or may not be driven. The dual wheel assembly 102 may include a smaller diameter wheel 106 and a larger diameter wheel 108.

Referring specifically to FIG. 1, a schematic view of the hybrid track and wheel system 100 shows the wheel assembly 102 and track 120 with small diameter wheel 106 contacting upper rolling surface 122 of the track 120. The hybrid track and wheel system 100 includes the wheel assembly 102, which can be mounted to a vehicle, not shown, and can travel both on track 120 and on road surface 130 (FIG. 2), as described herein.

The figures show a single dual wheel assembly 102. Normally vehicles such as cars, buses, etc., have at least four wheel assemblies (three wheel assemblies are rare). However, it is possible that it may have more wheel assemblies such as a six-wheel bus. It is understood that whatever number wheel assemblies 102 is dependent upon the type of vehicle, loading, etc., more so than it is on the functioning of this concept. In order to simplify the details and the description of the embodiments, a single dual wheel assembly 102 is shown. However, any number of wheel assemblies necessary for the proper functioning of the vehicle may be used, which may be selected to move the vehicle on the track 120 and/or on the road surface 130.

Referring now to FIG. 2, a schematic view of the hybrid track and wheel system 100 that shows the larger diameter wheel 108 contacting the road surface 134.

FIG. 3 is a schematic view of the hybrid track and wheel system 100 with larger diameter wheel 108 contacting the road surface 130.

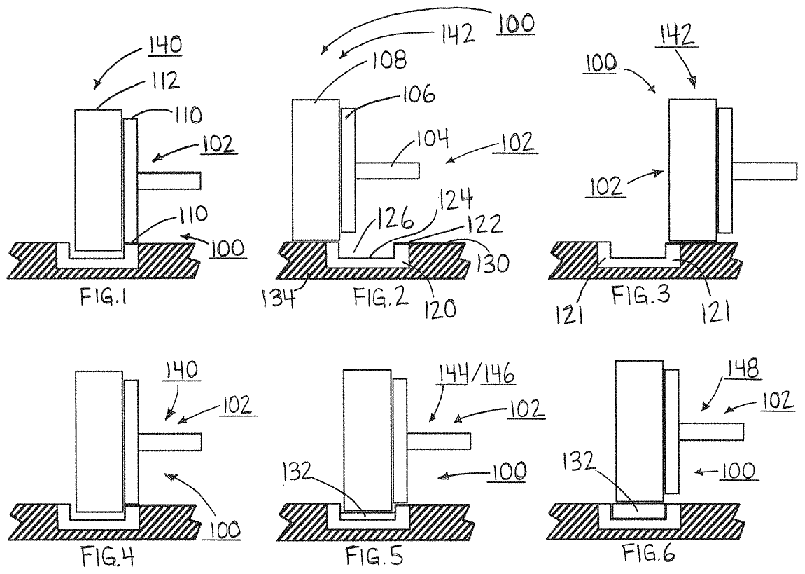

FIG. 4 is a schematic view of the hybrid track and wheel system 100 with small diameter wheel 106 contacting upper rolling surface 122.

FIG. 5 is a schematic view of the hybrid track and wheel system 100 with large diameter wheel 108 beginning to make contact with riser ramp 132 of the track in an ascending 144 or descending 146 position.

FIG. 6 is a schematic view of the hybrid track and wheel system 100 with a large diameter wheel 108 now making full contact with riser ramp 132 of the track at a raised position 148.

In a normal track position 140, a contact surface 110 of smaller diameter wheel 106 makes contact with upper rolling surface 122 of track 120 thereby allowing of the wheel assembly 102 to move rollably along the upper rolling surface 122 of track 120. Additionally, a portion of large diameter wheel 108 is partially extending into trough 126 defined by track 120 thereby ensuring that small diameter wheel 106 maintains its contact on the upper rolling surface 122 of track 120.

In a road position 142 shown in both FIGS. 2 and 3, the wheel assembly 102 has climbed out of the trough 126 of track 120 such that the road support surface 112 of large diameter wheel 108 makes contact with road surface 130 thereby the vehicle is now supported by large diameter wheel 108 whereas in the track position 140 the vehicle is supported by smaller diameter wheel 106. The track 120 is preferably “U” shaped however may take on other shapes such as “L” shaped and/or partially “U” shaped where one vertical leg is shorter than the other. In this example we are showing track 120 as “U” shaped. Track 120 includes a lower surface 124 and an upper rolling surface 122 as stated previously.

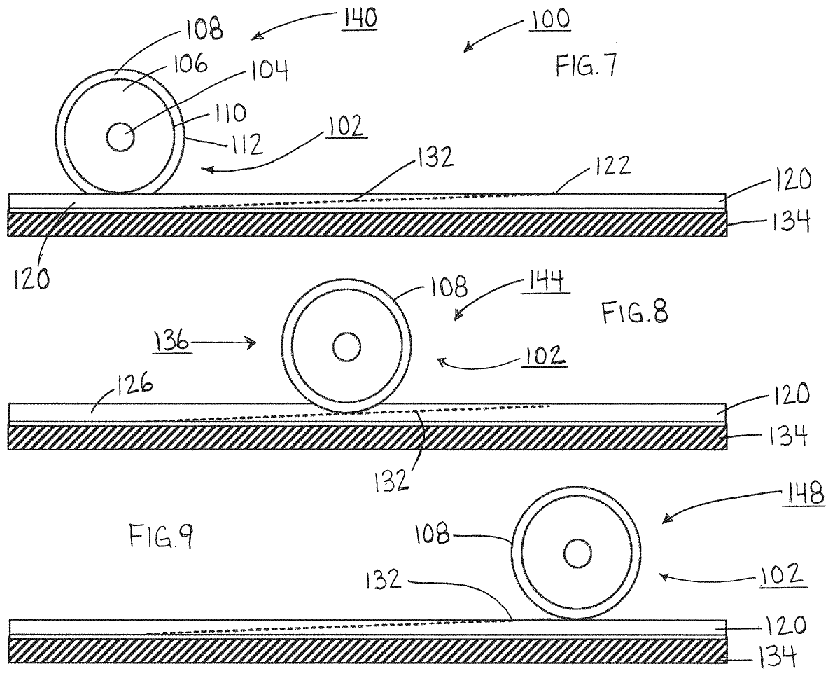

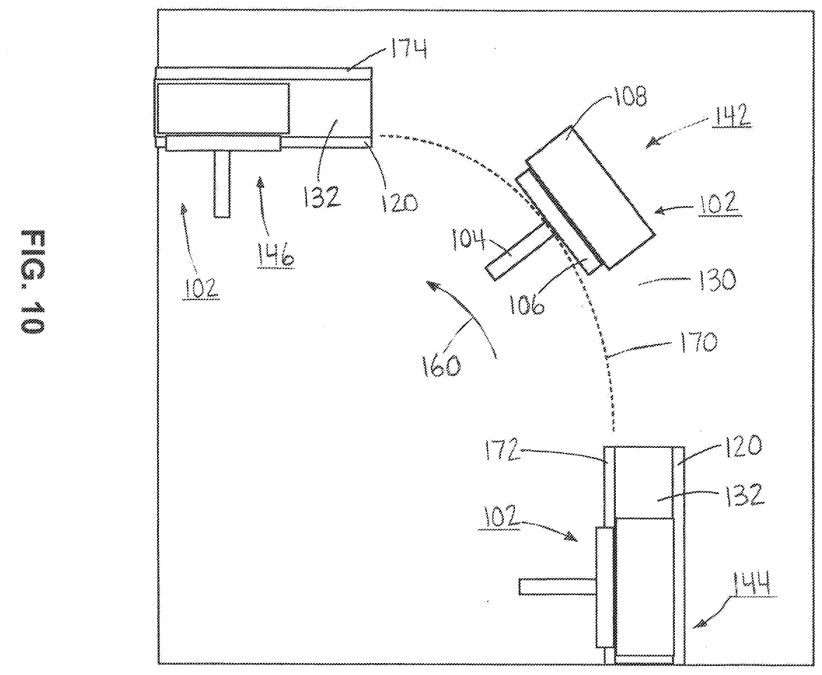

In order for the large diameter wheel 108 to climb out of the trough 126 of track 120 there are a number of options which are possible. Firstly, one could use a riser ramp 132 which is shown in FIGS. 5 and 6, as well as FIGS. 7, 8 and 9.

Riser ramp 132 as the name suggests is a wedge-shaped filler that goes into trough 126 at a low sloping incline such that the wheel assembly may ascend or descend on the riser ramp when the road support surface 112 of large diameter wheel 108 makes contact with riser ramp 132 as shown in FIGS. 5 and 8.

Wheel assembly 102 may be in an ascending position 144 or a descending position 146 depending on the direction of travel along riser ramp 132.

FIG. 5 shows the road support surface 112 of larger diameter wheel 108 just making contact with riser ramp 132 therefore beginning the incline or decline of the wheel assembly 102 along riser ramp 132.

FIG. 6 shows the wheel assembly 102 in a raised position 148 namely wherein riser ramp 132 completely just fills trough 126 such that the top of riser ramp 132 is level with the road surface 130 thereby large diameter wheel 108 can now easily move away or out of track 120. This is further shown in FIGS. 7, 8 and 9 wherein starting from the top of FIG. 7 to the bottom of FIG. 9 the wheel assembly 102 is moving in direction of travel, denoted by arrow 136, namely from left to right and one can see how the road support surface 112 of large diameter wheel 108 makes contact with the riser ramp 132 in FIG. 8 and climbs upwardly out of the trough 126 of track 120 as shown in FIG. 9 in the raised position 148.

Specifically, FIG. 7 is a schematic partial cross sectional and partial side elevational view of the wheel assembly 102 positioned within the track 120 such that the small diameter wheel 106 makes contact with the upper rolling surface of the track 120 and wherein the wheel is approaching the riser ramp 132 shown in dashed lines.

FIG. 8 is a schematic partial cross-sectional side elevational view of the wheel assembly 102 showing the large diameter wheel 108 making contact with the riser ramp 132 in an ascending position. For example, FIG. 8 shows the ascending position 144 due to the direction of travel 136, however could easily also be the descending position if the direction of travel is simply reversed.

FIG. 9 is a schematic partial cross-sectional side elevational view of the wheel assembly 102 showing the large diameter wheel 108 now having reached the top of the riser ramp 132 in the raised position.

FIG. 10 is a top schematic plan view of a wheel assembly 102 together with two tracks 172, 174 shown spaced apart and perpendicular to each other and wherein the wheel assembly 102 is shown in three separate positions when it moves from the first track 172 along an ark 170 to a second track 174 which is spaced away from and is perpendicular to the first track 172. In FIG. 10 the top schematic plan view shows the wheel assembly 102 rollably moving in the direction of arrow 160 along a first track 172 and into a road position 142 off a first track along an ark 170 onto a second track 174. The reader will note that wheel assembly 102 may be steerable wheel assembly as shown in FIG. 10 in that they can be directed to move along an ark 170 on road surface 130 in similar fashion as conventional automobile or bus steering systems. In order for the wheel assembly 102 to climb out of first track 172 there would be a riser ramp 132 within first track 172 allowing the wheel assembly to climb out of the track 120 and subsequently in order for the wheel assembly to climb into or roll into the second track 174 there would be a riser ramp 132 which allows the wheel assembly to descend into second track 174. So therefore, one is able to move in and out of tracks 120 by having riser ramps 132 at strategic locations of the track 120 allowing the wheel assembly 102 and therefore a vehicle connected to the wheel assembly 102 to move in and out of tracks 120 and also to move along the road surface 130. It is also possible that the wheel assembly 102 could climb out of the trough 126 of track 120 by simply turning out of trough 126 in similar fashion as a screwdriver bit will come out of a screw head. For example, it is well known that a screwdriver whether it be a Phillips, Robertson, or simply a blade type screwdriver can easily come out of the screw head if excessive turning force is used and not enough down pressure is applied on the screwdriver bit. In similar fashion wheel assembly 102 can come out of the trough 126 of road surface 130 depending upon the amount of turning force that is used and the difference in height between lower surface 124 and the road support surface 112 of large diameter wheel 108.

The reader will note that the road support surface 112 is above the lower surface 124 of track 120 therefore allowing one to come out of the track 120 by steering either to the left or to the right of the track 120. One can aid earning out by strategically lowering one or both vertical portions of the U-shaped track 120 in areas where it is desirable to leave the track. In this way the reader will note that a vehicle using wheel assembly 102 can either travel along a track 120 on the small diameter wheel 106 or on top of the road surface 130 using large diameter wheel 108. In practice smaller diameter wheel 106 may in fact be a metal wheel and large diameter wheel 108 may be a rubber wheel, however the material choice will depend upon the dimensions of track 120 and the methods chosen by which wheel assembly 102 can climb out of trough 126. Therefore, by supporting a vehicle with multiple wheel assembly 102 in combination with a track 120 and a road surface 130 one has a very flexible vehicle capable of running along a track or steer-ably along a traditional road surface 130.

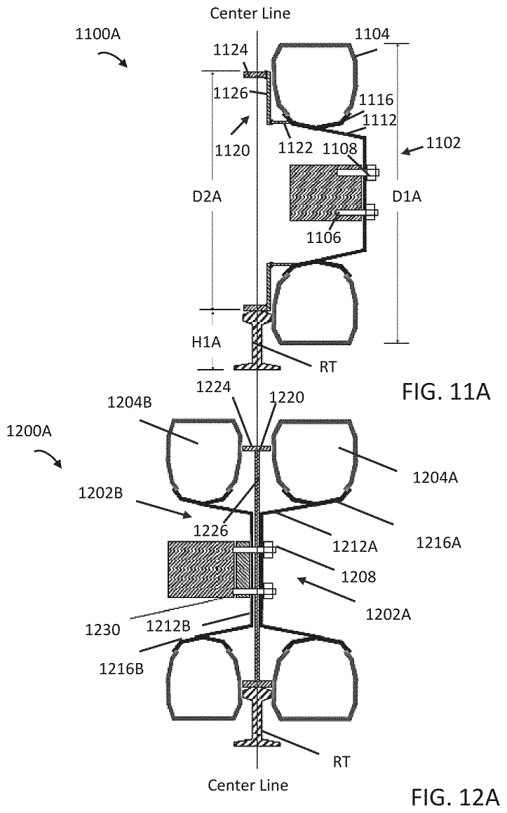

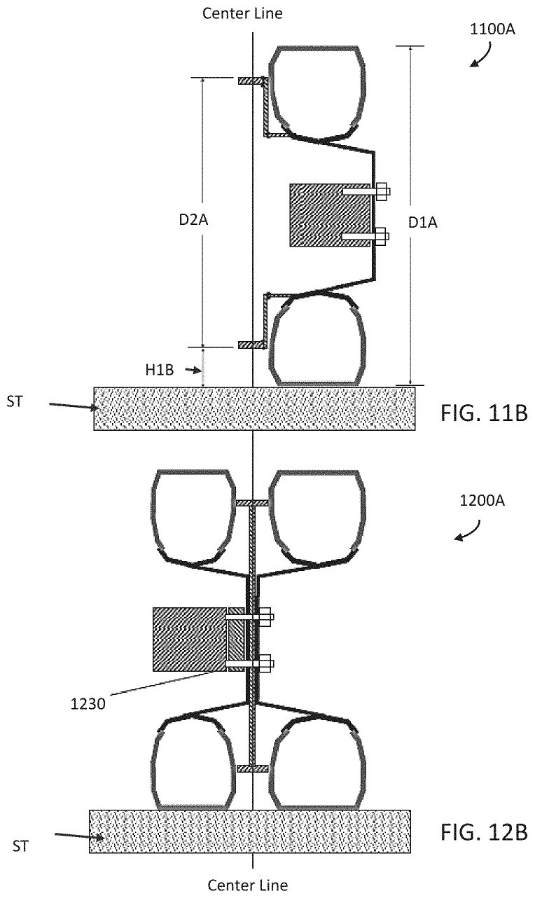

FIG. 11A illustrates a cross-sectional view of a dual wheel assembly 1100A on a rail track RT. The rail track RT has an I-beam configuration. The dual wheel assembly 1100A may be used in the hybrid track and wheel system 100.

FIG. 11B illustrates a cross-sectional view of a dual wheel assembly 1100A on a surface of a road or street ST. The dual wheel assembly 1100A may include a dual wheel hub 1102 and a tire 1104 (i.e., large diameter wheel 108 of FIG. 2). The dual wheel hub 1102 may include a hub body 1112 having a tire rim 1116 configured to connect to the tire 1104. The tire 1104 is installed on the rim and the interface between the tire and rim 1116 holds air in the tire to keep the tire inflated, for example. The dual wheel assembly 1100A may be on the front wheel axle. In some embodiments, the dual wheel assembly 1100A is a front dual wheel assembly. In various embodiments, the dual wheel assembly 1100A may be used on a rear wheel axle and serve as a rear dual wheel assembly. Tire 1104 may be pneumatic, non-pneumatic, special high-pressure pneumatic or made of a compliant material. The non-pneumatic or special high-pressure pneumatic tires may be selected to minimize the trough depth for a streetcar system embodiment.

The dual wheel hub 1102 may include a rail wheel 1120 (i.e., smaller diameter wheel 106 of FIG. 2) integrated into the body 112 of the dual wheel hub 1102. The rail wheel 1120 may include an inner hoop 1122, an outer hoop 1124 and a ring 1126. The inner hoop 1122 is connected to the hub 1102 and radiates therefrom so that the inner hoop 1122 is essentially parallel to a road surface. In various embodiments, the inner hoop is connected to an inner exterior side of the rim. The inner hoop 1122 has one end connected to the rim, for example, and a second free end connected to an inner surface of the ring 1126. The outer hoop 1124 may be connected to an outer surface of the ring 1126. The rail wheel of FIG. 11A does not include a flange that would be oriented generally perpendicular to the outer hoop to extend along a side of the rail track. The flange is subject to damage when driving on and off a rail. The flange may also cause friction with the side of a rail track.

The dual wheel hub 1102 may include a plurality of apertures dimensioned to receive lug nuts 1108 to fasten the hub 1102 to bolts 1106 of the vehicle. The wheel hub 1102 may be between the vehicle axle and the disc brakes (not shown). The wheel hub 1102 may be connected to a steering knuckle (not shown). The wheel hub 1102 may include bearings, and a speed sensor. If the vehicle has a traction control system and anti-lock braking system, the sensors may work together for traction and braking operations of the vehicle.

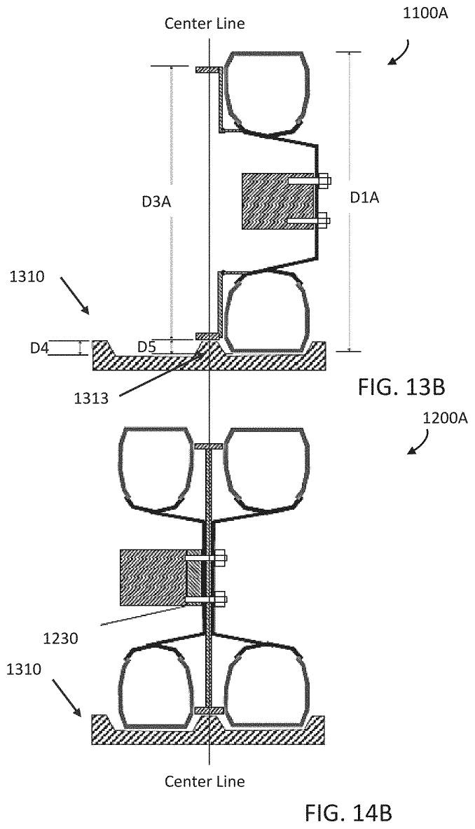

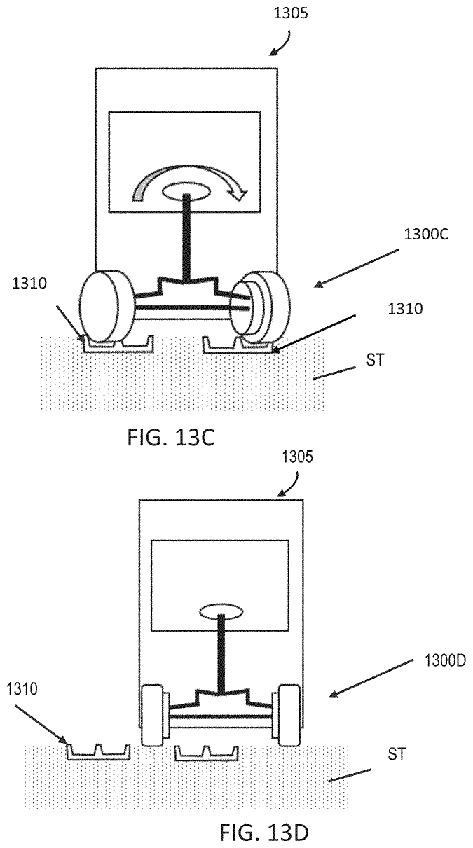

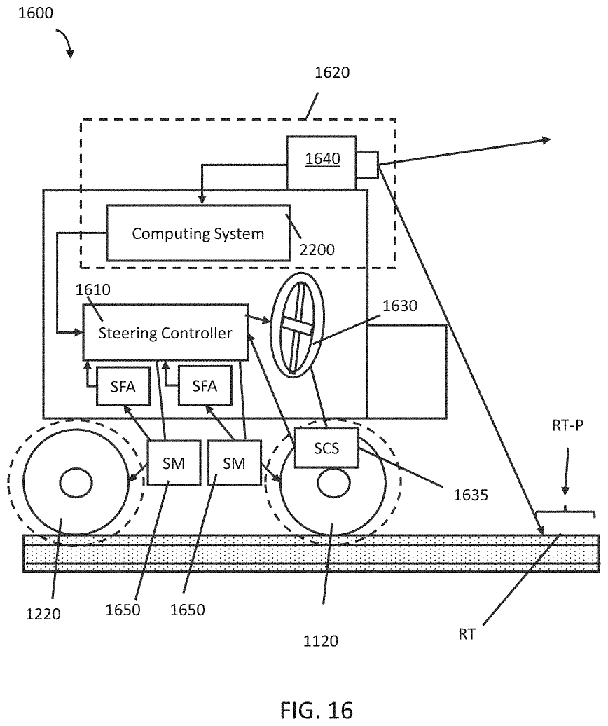

In operation, while riding on the rail track RT, the braking system may include an ABS braking system with a rail braking mode. The same steering knuckle, used to steer the wheel hub 1102 for driving using tire 1104, is used to steer the rail wheel 1120. In some embodiments, the rail wheel 1120 may have its own independent steering knuckle when on the rail track. As will be described in relation to FIG. 16, the rail wheel 1120, while shown rigidly affixed to the wheel hub 1102, may be adjustably coupled to the wheel hub 1102 via a servo motor so that the rail wheel 1120 may be adjusted relative to the wheel hub 1102 so that the rail wheel 1120 can be aligned on a rail track, such as an I-beam track or center rail 1313 (FIG. 13A).

In the example of FIG. 11A, the outer surface to outer surface of the tire 1104 has a diameter D1A of approximately 42 inches. The outer surface to outer surface of the outer hoop 1124 has a diameter D2A of approximately 36 inches. The height H1A of the rail track RT is approximately 6 inches. In FIG. 11B, the height H1B is from the road surface of street ST and the outer surface of the outer loop 1124.

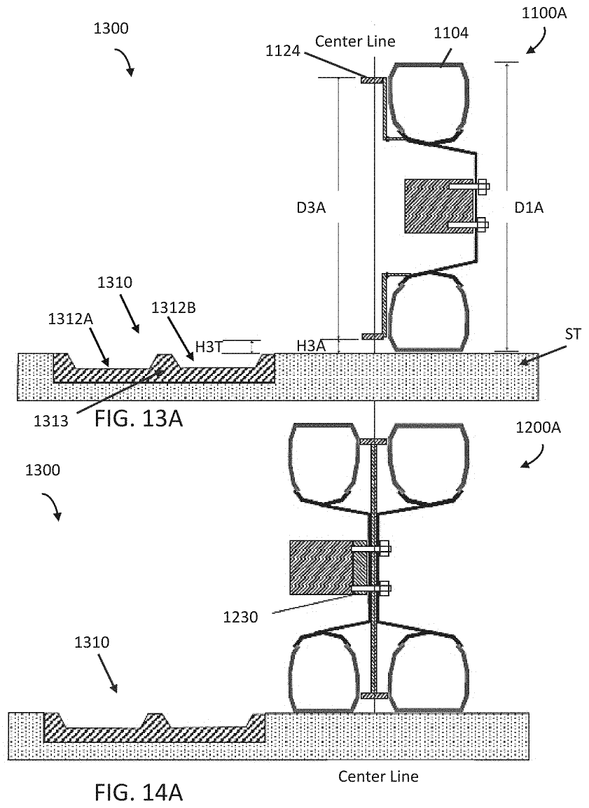

FIG. 12A illustrates a cross-sectional view of a rear triple wheel assembly 1200A on a rail track RT.

FIG. 12B illustrates a cross-sectional view of the rear triple wheel assembly 1200A on a surface of a road or street ST. FIGS. 11A and 12A illustrate an aligned dual wheel assembly 1100A and rear triple wheel assembly 1200A for a passenger side of a vehicle. The triple wheel assembly 1200A may include a first wheel hub 1202A and a second wheel hub 1202B. The triple wheel assembly 1200A may include a first tire 1204A, second tire 1204B, and a rail wheel 1220. Although the rear triple wheel assembly 1200A is described for a rear axle of a vehicle, in some embodiments the triple wheel assembly 1200A may be used on a front axle of a custom vehicle.

The first wheel hub 1202A may include a hub body 1212A having a tire rim 1216A configured to connect to the tire 1204A. The tire 1204A is installed on the rim 1216A and the interface between the tire and rim 1216A holds air in the tire to keep the tire inflated, for example.

The second wheel hub 1202B may include a hub body 1212B having a tire rim 1216B configured to connect to the tire 1204B. The tire 1204B is installed on the rim 1216B and the interface between the tire and rim 1216B holds air in the tire to keep the tire inflated.

The first wheel hub 1202A and second wheel hub 1202B have a spacing therebetween. A rail wheel 1220 is disposed in the spacing between first wheel hub 1202A and second wheel hub 1202B. The rail wheel 1220 may include an outer hoop 1224 and central disc 1226. The outer hoop 1224 may be connected to an outer surface of the central disc 1226. The central disc 1226 may include apertures, which are aligned with apertures of the first wheel hub 1202A and a second wheel hub 1202B. The central disc 1226 may be a planar flat member having the outer hoop 1224 affixed to the outer perimeter of the central disc 1226.

In some embodiments, the triple wheel assembly 1200A may include a spacer 1230 to align a front mounted rail wheel (i.e., rail wheel 1120) with a rear mounted rail wheel (i.e., rail wheel 1220). The spacer 1230 may include apertures aligned with the apertures of the first wheel hub 1202A and a second wheel hub 1202B, all of which are bolted to the vehicle by bolts 1208.

FIG. 13A illustrates a cross-sectional view of a dual wheel assembly 1100A on a surface of a road or street adjacent to a trough rail track 1310 of a hybrid track and wheel system 1300. The hybrid track and wheel system 1300 includes dual wheel assembly 1100A and a trough rail track 1310.

FIG. 13B illustrates a cross-sectional view of the dual wheel assembly in a trough rail track of the hybrid track and wheel system 1300. The trough rail track 1310 has two side-by-side wheel wells 1312A, 1312B (e.g., troughs) which share a center rail 1313 along which the rail wheel rolls and having an E-shape rotated 90° counterclockwise. The wheel wells are configured to support the dual wheel assembly 1100A, as shown in FIG. 13B and the triple wheel assembly 1200A, as shown in FIG. 14B. A portion of the longitudinal length of the trough rail track 1310 may include a riser ramp (i.e., riser ramp 132).

In the example of FIG. 13A, the outer surface to outer surface of the tire 1104 has a diameter D1A of approximately 42 inches. The outer surface to outer surface of the outer hoop 1124 has a diameter D3A of approximately 38 inches. The height H3A of the rail track RT is approximately 2 inches from the road surface of street ST and the outer surface of the outer loop 1124. The height H3T is from the outer surface of the outer loop 1124 to the top surface of the track 1310 and measures approximately 2.25 inches.

In the illustration of FIG. 13B, the depth D4 of the trough or wheel well is approximately 2.25 inches. The depth D5 is approximately 2 inches, which corresponds to the height of the center rail 1313 of the track 1310 above the bottom of the trough or wheel wells 1312A, 1312B (FIG. 13A).

FIG. 14A illustrates a cross-sectional view of a rear triple wheel assembly 1200A on a surface of a road adjacent to a trough rail track 1310. The hybrid track and wheel system 1300 may also include the rear triple wheel assembly 1200A. The trough rail track 1310 may include a riser ramp 132 (FIG. 7) to allow the transition of the wheel assemblies onto or off the road or street ST.

FIG. 14B illustrates a cross-sectional view of the rear triple wheel assembly 1200A in a trough rail track 1310 of the hybrid track and wheel system 1300.

In FIGS. 13A and 13B and 14A and 14B, the rail track RT of FIG. 11A may be modified to include, at cross-roads, offramp or onramp, such as the trough rail track 1310 or track 120 so that there is a smooth transition one and off of the rail track RT. The center track 1313 may be aligned with the I-beam configuration of the rail track RT.

FIG. 13C illustrates a vehicle 1305 having a pair of front dual wheel assemblies 1300C of turning out of trough rail tracks 1310.

FIG. 13D illustrates a pair of front dual wheel assemblies 1300D of vehicle 1305 out of trough rail tracks 1310 and on street ST. The vehicle 1305 may be a bus, truck, car, flatbed truck or other vehicle with at least one two tires.

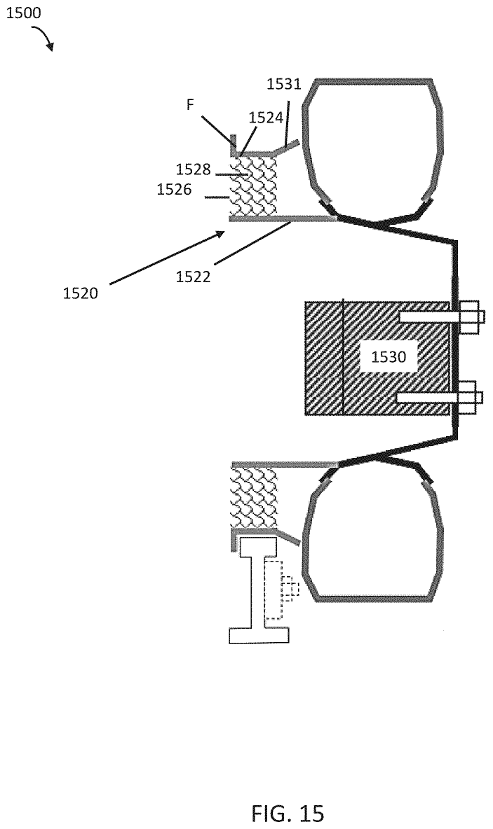

FIG. 15 illustrates a cross-sectional view of a front dual wheel assembly with a vibration compensation. The dual wheel assembly 1500 is similar to the dual wheel assembly 1100A, therefore, only the differences will be described. The rail wheel 1520 may include an extended inner hoop 1522, an outer hoop 1524 and a vibration dampening ring 1526. The vibration dampening ring 1526 may include a vibration dampening structure 1528. The dampening structure 1528 may include a lattice or other structure. The vibration compensation may also be incorporated in the central disc 1226 of the rear triple wheel assembly 1200A.

The outer hoop 1524 is shown with an inboard flange F. However, the flange F may be omitted from the outer hoop 1524. The outer loop 1524 may include an angled deflector 1531. In the illustration, a spacer 1530 is shown.

Although the rail wheel is shown fastened to the wheel hub, the rail wheel may be independently coupled to an axle.

The embodiments may use autonomous driving and/or a computer vision system to align the rail wheels of the vehicle with the rail tracks for high-speed transition from road mode to rail mode. The embodiments may use autonomous driving and/or computer vision system to maintain the rail wheel aligned on the rail tracks when in rail mode for the highest efficiency possible. The autonomous driving may cause the vehicle to while driving, maintain a generally centered alignment in the direction of travel in a lane of a road or street, avoid collisions on a road or rail and navigate a route safely.

The embodiments may operate the vehicle in a full autonomous mode with or without a driver in either road mode or rail mode. The vehicle may operate in a semi-autonomous mode.

FIG. 16 illustrates a block diagram of a vehicle 1600 with an autonomous rail wheel control system to control rail wheels 1120 (FIG. 11A) and rail wheels 1220 (FIG. 12A).

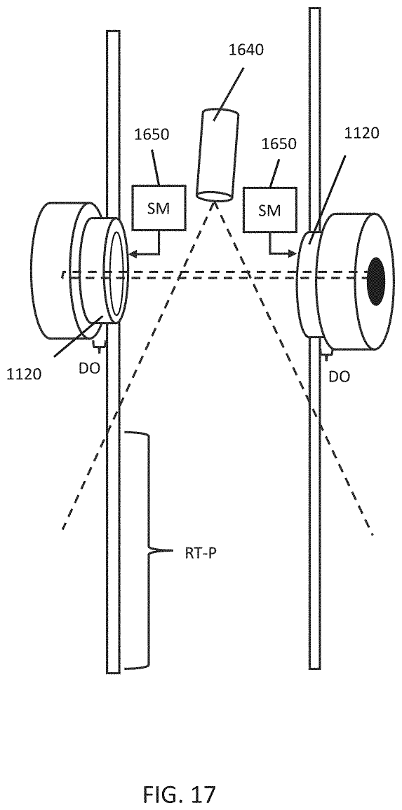

FIG. 17 illustrates a block diagram of servo motors 1650 of the rail wheel control system controlling rail wheels 1120 (FIG. 11A). The tires are represented as dashed circles.

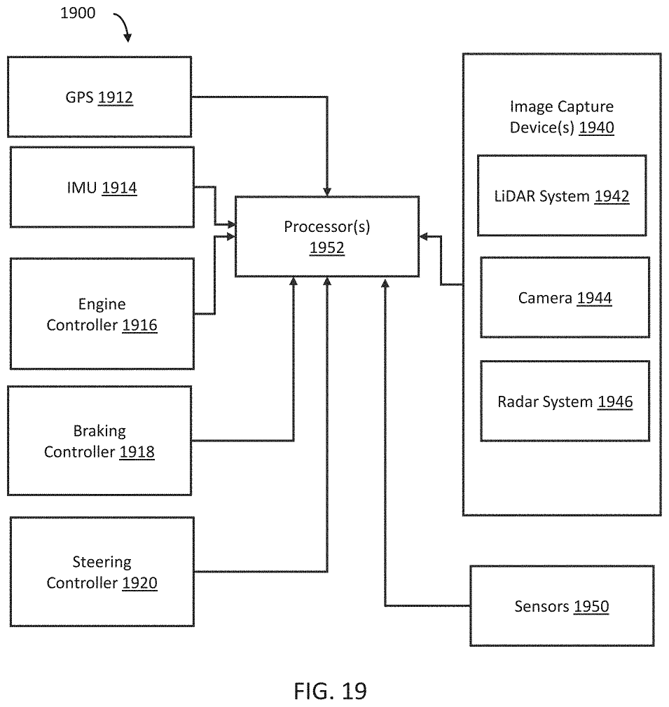

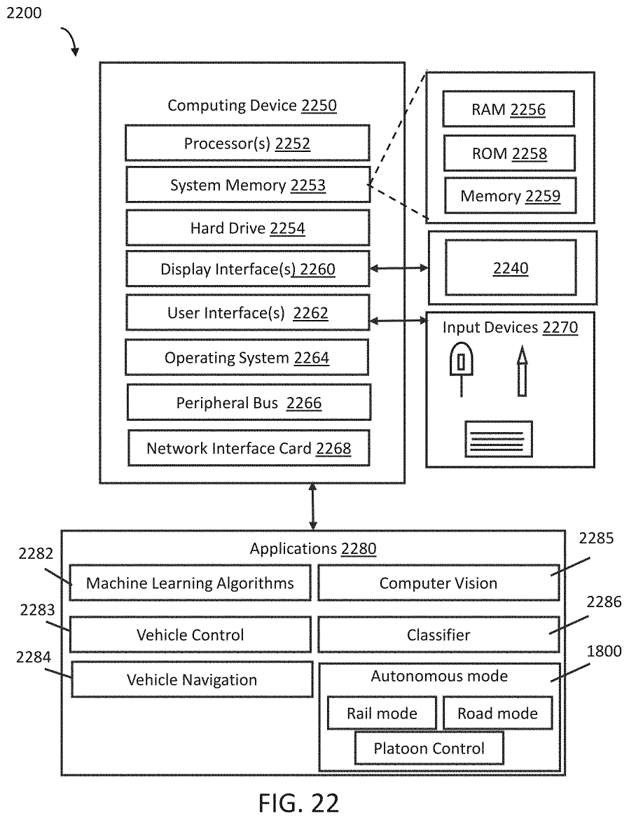

The rail wheel control system may include a computing system 2200 (FIG. 22) or electronic computing device. The rail wheel control system may include a computer vision system 1620 that may include the computing system 2200 or another processor. The computer vision system 1620 that may include one or more image capture devices 1640 (i.e., image capture devices 1940 of FIG. 19) to capture images of eminent rail track portions RT-P in the direction of travel of the vehicle. The rail wheel control system may include rail wheel controllers 1650. The rail wheel controllers 1650 may include a servo motor (SM) configured to adjust the rail wheel or the rail wheel 1120 and the tire 1104 to align width of the outer hoop 1124 with the width of the rail track surface, for example. The alignment keeps the outer hoop on the rail track as the rail track varies.

A one or more image capture devices 1640 (e.g., a camera and/or a spatial sensing system) locate the rails as they relate to the vehicle location, direction of motion, and speed, such that a computerized steering controller 1610, working with servo feedback actuators (SFAs) operating the steering mechanism 1630, will align the vehicle to transition onto the rail tracks from the road with absolute location accuracy so the (steel) rail wheels 1120 ride onto the steel rail track RT with minimal disturbance of the vehicle's motion. Although a steering wheel is shown, a steering wheel may be omitted for fully autonomous vehicle.

Once operating with (steel) rail wheels 1120 on steel rail tracks, the computer vision system 1620 (i.e., spatial sensing system) would modulate the steering of the wheels so that there is minimum reliance on or elimination of wheel flanges in order to locate the vehicle on the rails, thus minimizing friction for the highest efficiency possible. Such a vehicle, in passenger or freight operation, would be able to physically utilize existing heavy rail lines, as well as any paved or concrete road, to minimize travel time, optimize energy efficiency, and optimize utilization of existing infrastructure, while minimizing carbon footprint. The minimization of friction improves fuel efficiency of the vehicle during rail track operation. Thus, in the scenario that a wheel flange is used on a rail wheel, the wheel flange should maintain a distance offset DO from the side of a rail track to eliminate the friction between the flange and the side of the rail track. In another scenario, the wheel flange is eliminated, and the computer vision system is used to keep the rail wheel on the rail track. In some scenarios, the computer vision system may also maintain a distance offset DO of the tire of the vehicle from the rail track, as shown in FIG. 17, to eliminate any friction between the tire of the wheel and the rail track.

In computing system 2200 (FIG. 22) or processor of the computer vision system may use machine learning algorithms 2282 (FIG. 22) to predict adjustments to the rail wheel to maintain the rail wheel aligned with the rail track. Machine learning algorithms 2282 may include feature extraction, classification, background subtraction, texture detection, and edge detection, for example, to isolate the rail track RT or center track 1313. Since each rail track RT or trough rail track may differ, feature extraction and classification may be used to determine which type of track is being used so that feature details of the track may be determined. Feature details may include the width of the track, I-beam shape, U-shape or E-shape. Other features may include turns, splits, transitions, and other rail features. The trough rail tracks have their own set of features. Moreover, the steering controller may be configured to maintain the wheels aligned or centered in the wheel wells of the trough rail tracks.

The steering control sensors (SCS) 1635 provide sensor information for determining the current steering position. The SCS 1635 sensor information may be used by the steering controller 1610 for aligning the wheels and turning the wheels based on the current wheel position.

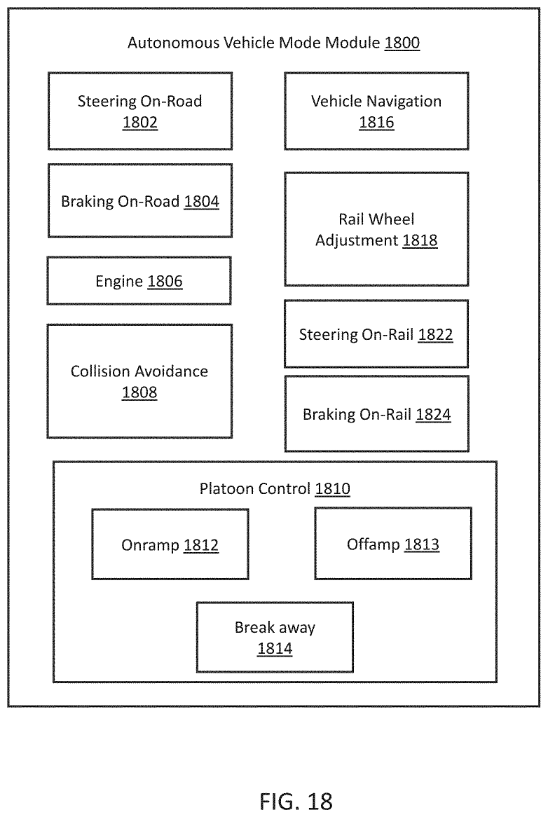

FIG. 18 illustrates a block diagram of an autonomous vehicle mode module 1800, which may include a steering on-road module 1802 and a braking on-road module 1804 to control the steering and braking of the vehicle (i.e., vehicle 1600 of FIG. 16) in an autonomous mode while traveling along a road or street ST. The vehicle may include a set of image capture devices 1940 (FIG. 19) to capture images 360° around the vehicle, which are part of the computer vision system 1620. The image data captured by the computer vision system 1620 may be used by a collision avoidance module 1808 to avoid collision with another vehicle or object. The collision avoidance module 1808 may allow for lane change with speed reduction and steering control when the vehicle is operating on a road or street ST. However, when on the vehicle is on a rail track, lane changes may not be an option to avoid a collision. Instead, a strict distance between a detected vehicle in the direction of travel may be adhered to by controlled braking, acceleration, or deceleration to avoid a collision. The computer vision system 1620 captures image data of the rail tracks. The collision avoidance module 1808 may detect objects across the rail tracks to stop the vehicle in order to prevent a collision between the vehicle and the object.

The engine module 1806 controls the engine's acceleration and deceleration during operation of the vehicle. A navigation module 1816 controls the path driven by the vehicle to arrive at a designated destination on a planned route, for example. The navigation module 1816 may interface with location sensors, such as a global positioning system (GPS) 1912 and IMU 1914, for example, to locate or determine a current position of the vehicle in a global map coordinate system. The navigation module 1816 may cause the vehicle to drive along a path to the planned final destination in a global map coordinate system. The tracks may be mapped according to a global map coordinate system for use by the navigation module 1816 so share the track based on traffic congestion, in some embodiments, with trains. streetcars and/or other vehicles capable of driving along the track.

The autonomous vehicle mode module 1800 may receive traffic congestion updates on both roads and rail tracks and determine which route or route portions are fastest using on-road operation or on-rail operation. In some embodiments, autonomous vehicle mode module 1800 may receive scheduled use of a rail track portion that may be along the planned route when determining traffic congestion. The autonomous vehicle mode module 1800 may select one or more of a road and rail track portion as the fastest route to navigate to a final destination. Navigation to a final designation may include intermittent o-road and on-rail track driving intervals based on current, predicted, or scheduled traffic conditions of at least one of the road and rail track along a route.

For on-rail operation, the autonomous vehicle mode module 1800 may include steering on-rail module 1822 and braking on-rail module 1824. The steering and braking of the vehicle while operating on the rail may have different constraints. For example, the braking distance may be different when using a pneumatic tire or large diameter tire for on road braking as compared to rail track braking using a steel wheel or small diameter wheel. In other words, a train type braking scheme may be adapted for use by a vehicle with a steel wheel on the rail track. In other embodiments, for a trough rail track type operation, the braking distance may be controlled by including tire braking in the wheel wells, at some locations such as the riser ramp portion.

The vehicle may have other sensors 1950 such as curb sensors to determine a distance from a curb when turning to control steering. Still further the sensors 1950 may include rail track sensors to detect imminent objects (e.g., track switches) of a rail track system.

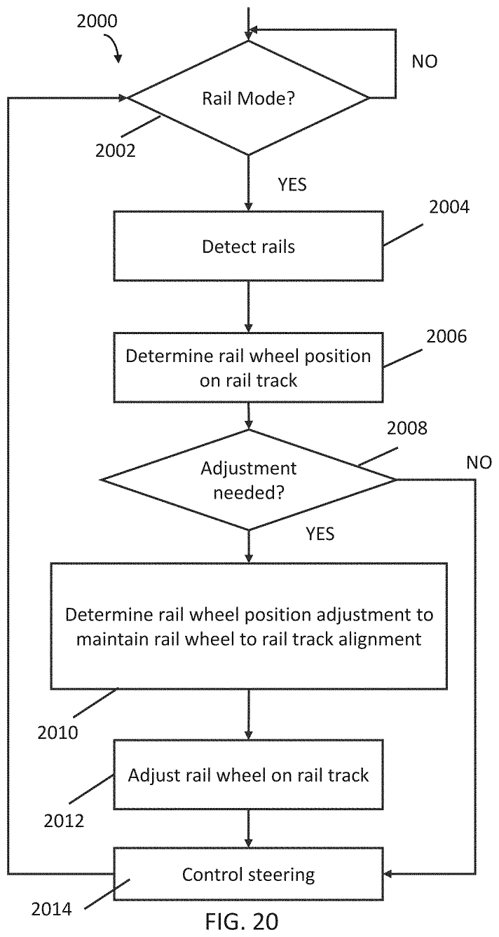

The autonomous vehicle mode module 1800 may include a rail wheel adjustment module 1818 to adjust the rail wheel. An example, process or adjusting the rail wheel is described below in relation to FIG. 20. The rail wheel adjustment module 1818 may be configured to maintain a flange on the rail wheel or a side of the pneumatic tire a distance offset DO (FIG. 17) from the side of the rail track, such as by using steering sensors, curb sensors or other rail track locating sensors. The distance offset DO (FIG. 17) is designed to prevent friction between the tire or flange, if present, and the side of the rail track.

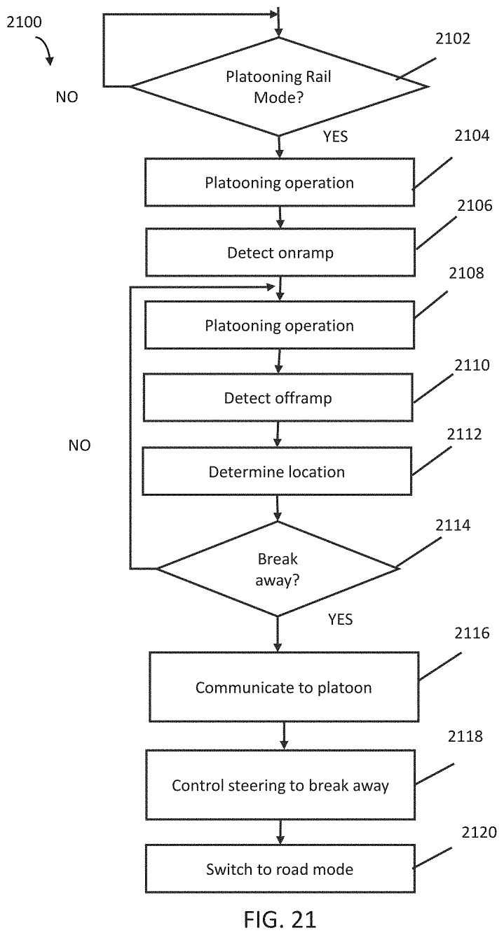

The autonomous vehicle mode module 1800 may include platoon control module 1810. An example, method for platoon control is described below in relation to FIG. 21. The platoon control module 1810 may include an onramp module 1812 and an offramp module 1813 to control the steering and driving of the vehicle while accessing the rail track using an onramp or an offramp. The onramp and offramp may include a track 120 with a riser ramp 132, as shown in FIGS. 7-9, or track 1310 with a riser ramp 132 for each wheel well (e.g., troughs). The riser ramp 132 may have both ascending 144 or descending 146 positions to use as an onramp or offramp. For example, steering onto the rail track differs based on whether the rail track is a trough rail track which provides two side-by-side wheel wells. Thus, the steering controller needs to control the steering and alignment of the pneumatic tires to align and maintain alignment with the wheel wells. For a rail track of an I-beam type, the steering controller steers the rail wheel onto the top surface of the I-beam and maintains alignment. The platoon control module 1810 may include a break away module 1814 to allow a vehicle to break away or depart a platoon. The onramp module 1812 may assist in joining a platoon in some embodiments.

FIG. 19 illustrates a block diagram of an autonomous vehicle control system 1900. The autonomous vehicle control system 1900 may include at least one processor 1952 (i.e., processor 2252 of FIG. 22) in communication with one or more of a global positions system 1912, an inertial measurement unit (IMU) 1914, an engine controller 1916, a braking controller 1918, and a steering controller 1920. The IMU may include accelerometer(s), gyroscope(s), and/or magnetometers. The vehicle control system 1900 may switch between GPS signals and IMU signals when GPS signals are not available to the vehicle. The GPS 1912 and IMU 1914 may be configured as location sensors to determining a location and/or position of the vehicle in a global map coordinate system.

The autonomous vehicle control system 1900 may include one or more image capture devices 1940 and vehicle operational sensors 1950 such as, without limitation, speed sensor(s), odometer sensor(s), fuel sensor(s), and ambient light sensor(s). The image capture devices 1940 may include a light detection and ranging (LiDAR) sensor system, an image capture device (such as a camera) and/or radar sensor system 1946.

In some embodiments, the vehicle may be an autonomous vehicle. In some embodiments, the vehicle may switch between manual vehicle driving operation, semi-autonomous driving operation and autonomous driving operation. For example, the vehicle when operating semi-autonomous and/or autonomous may have a rail mode and a road mode.

Semi-autonomous and autonomous driving of the vehicle in the rail mode may eliminate a swerving option to avoid a collision with an object in the path. Additionally, in the rail mode, the breaking distance may be different to bring the vehicle to a complete stop or to decelerate.

In some embodiments, the autonomous driving of the vehicle may include a platoon rail mode of operation. The vehicle may be caused to drive (by a human operator or autonomously) on road or pavement of a dock of a shipping port to an off-loading area. The vehicle, while on a paved road or other road, receives a container lifted off the ship, for example. Then, the loaded vehicle is driven (by a human operator or autonomously) on the road to an onramp for accessing a rail track (i.e., rail track RT, track 120 or track 1310) of a railway system. Onramps (i.e., track 120 or track 1310) may be used as staging ramps for drivers to leave the vehicle to platoon in an autonomous mode. Offramps (i.e., track 120 or track 1310) could be staging ramps for drivers to pick up a vehicle after leaving a platoon autonomously. While on rail tracks, the vehicle may combine with other vehicles in a platoon for energy and operator efficiency, allowing for autonomous operation while the driver(s) rest, in some embodiments. One or more individual vehicles break away from the platoon as they get to their offramps and drive to their destinations on the road. In some embodiments, the vehicle may operate in a platoon mode while driving on a road or street with other vehicles. The autonomous driving mode may use the location information from the GPS to determine the next available offramp.

The methods described herein may be performed in the order shown or a different order. In some embodiments, one or more of the steps may be performed contemporaneously. In some embodiments, one or more of the steps may be deleted or additional steps added. The methods may be implemented using software, hardware, firmware or a combination of software, hardware and/or firmware.

FIG. 20 illustrates a flowchart of a method 2000 for adjusting a rail wheel. The method 2000 may include determining if the vehicle is in a rail mode (at 2002). If the determination (at 2002) is “YES,” the method 2000 may detect rail tracks (at 2004), such as by using a computer vision system and machine learning algorithms. If the determination (at 2002) is “NO,” the method 2000 may loop to the beginning, such as the beginning of step 2002. After detecting the rail tracks (at 2004), the method 2000 may (at 2006) determine the position of the rail wheel on the rail track. Method 2000 may (at 2008) determine if an adjustment of the rail wheel relative to the rail track is needed based on the determining rail wheel position. If the determination (at 2008) is “YES,” the method 2000 may (at 2010) determine the rail wheel position adjustment to maintain the rail wheel to rail track alignment. If the determination (at 2008) is “NO,” the method 2000 controls the steering (at 2014) of the vehicle.

The method 2000 may (at 2012) adjust the rail wheel on the rail track and control steering (at 2014). By way of non-limiting example, a servo motor may be used to adjust the rail wheel, as shown in FIGS. 16 and 17. The method 2000 repeats the rail wheel alignment as necessary during the rail mode of operation.

In various embodiments, the vehicle may be used for freight delivery using one of the roadways or a rail track system for route sharing with trains, street cars or other rail driven vehicles. This allows for freight to be consolidated on a freight-sharing platform that puts everything going to a particular location (i.e., Chicago), from one or more sources in one container or vehicle.

A container may come off a ship and go on a vehicle that drives on the road to an onramp to a rail track or trough rail track. Then while the vehicle is on rails, the vehicle may combine with other vehicles in a platoon for energy and operator efficiency, allowing for autonomous operation while the driver(s) rest, for example. Vehicles may break away from the platoon as they get to their offramps and drive to their destinations on the road. Propulsion may be by flash charged electric or hydrogen fuel cell technology. In some embodiments, an existing vehicle may be converted to an electric or hydrogen fuel vehicle. In some embodiments, the dual mode vehicles may be a dedicated vehicle built for 56.5″ gauge rail tracks with electric or hydrogen fuel. In other embodiments, vehicles may be diesel fueled and adapted for rail use using a 75″ wide gauge.

FIG. 21 illustrates a flowchart of a method 2100 for platooning in a rail mode. Although the description of method 2100 is directed to platooning, the method may also be used in the autonomous mode without platooning. The vehicle may operate in a platooning mode on the road, as well. The method 2100 may determine if the vehicle is in a platooning rail mode (at 2102). If the determination (at 2102) is “YES,” the method 2100 may cause the vehicle to be navigated according to a platooning operation (at 2104), such as by using a computer vision system to detect a vehicle of the platoon ahead of the vehicle. If the determination (at 2102) is “NO,” the method 2100 may loop to the beginning, such as the beginning of step 2102.

The platooning operation may require an ordered entry into the rail track pathway. Therefore, after the vehicle is loaded with goods or passengers, for example, the vehicle may line up to enter a platoon. The platoon may include two or more vehicles.

The method 2100 may (at 2106) detect an onramp, such as by using a computer vision system or other sensor, for entering a rail track system. In some embodiments, the onramp may be determined by stored GPS location coordinates. The method 2100 may (at 2108) continue with platooning operation by entering the onramp such that the rail wheel aligns with the rail track or the center track of a trough rail track 1310, each requires a different alignment procedure. For example, the rail track may orient the on-road wheels suspended above the underlying surface. In the trough rail track 1310, at least one wheel is positioned in a trough with the rail wheel aligned with the center rail of track 1310. Although two examples are shown, other rail track configurations may be provided. In any scenario, the vehicle is controlled using a computer vision system to align the rail wheel with the designated rail track location.

The platooning operation may reduce the distance between the vehicles on the rail track or trough rail track. The autonomous driving mode may control the vehicle to achieve and maintain the distance for platooning two or more vehicles.

The method 2100 may (at 2110) detect an offramp, such as by using a computer vision system or other sensor. In some embodiments, the offramps may be determined by stored GPS location coordinates. The method 2100 may (at 2112) determine a location of the offramp, such as to plan a break away maneuver. The breakaway maneuver may break away from the platoon or break away from the rail track system. The method 2100 may (at 2114) determine if the vehicle needs to break away. If the determination (at 2114) is “NO,” the method loops to the beginning of step 2108. If the determination (at 2114) is “YES,” the method 2100 may (at 2116) cause the vehicle to communicate with at least one vehicle of the platoon. The vehicles in the platoon may communicate with each other. For example, when a vehicle is breaking away from a platoon, one or more vehicles in at least one of the front and/or rear of the breaking away vehicle may be notified of the departure so that the platoon can be reformed along the rail track or trough rail track.

The method 2100 may (at 2118) control the steering of the vehicle to break away. The method 2100 may (at 2120) cause the vehicle to switch to the autonomous road mode.

FIG. 22 illustrates a special-purpose computer system 2200. The computer system 2200 may be in an electronic device, a personal computer, laptop, or a server, for example. The computer system 2200 may include a computing device 2250, which may also have additional features or functionality. For example, the computing device 2250 may also include one or more processors 2252 and an operating system 2264 stored in a hard device 2254. The operating system 2264 may be configured as programming instructions which may be executed by the one or more processors 2252. The computing device 2250 may include additional data storage devices (removable and/or non-removable) such as, for example, magnetic disks, optical disks, or tape. Computer storage media may include volatile and non-volatile, non-transitory, removable, and non-removable media implemented in any method or technology for storage of data, such as computer readable instructions, data structures, program modules or other data. System memory 2253, removable storage and non-removable storage are all examples of computer storage media. Computer storage media includes, but is not limited to, RAM 2256, ROM 2258, Electrically Erasable Read-Only Memory (EEPROM), flash memory 2259 or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data and which can be accessed by the computing device. Any such computer storage media may be part of the device. The computer system 2200 may include applications 2280 such as without limitation machine learning algorithms 2282 and vehicle control 2283 for autonomous operation or semi-autonomous operation and/or platooning. The applications 2280 may include computer vision algorithms 2285 and a classifier 2286 to classify the different rail tracks such as an I-beam, U-shaped and E-shaped tracks, and/or classifying objects, such as without limitation, vehicles, bicycles, trains, trucks, buses, streetcars, scooters, traffic lights, traffic signage, road markings, curbs, pedestrians, animals, rail markings, bridges, parking lots and parking structures. The applications 2280 may include vehicle navigation modules 2284 that may be used in semi-autonomous or human driving modes. The applications 2280 may include the autonomous mode module 1800 with a rail mode, a road mode and platoon control. The applications 2280 may be in the form of program code, program modules, and micro-code.

The computing device 2250 may also include or have user interfaces 2262 for user input device(s) 2270 such as a keyboard, mouse, pen, voice input device, touch input device, etc. The computing device 2250 may include or have display interfaces 2260 for connection to output device(s) such as at least one display device 2240 via display drivers, speakers, etc. The computing device 2250 may include a peripheral bus 2266 for connecting to peripherals. The computing device 2250 may contain communication connection(s) that allow the communication systems to communicate with other computing devices, such as over a network or a wireless network. By way of example, and not limitation, communication connection(s) and protocols may be compatible with wired media such as a wired network or direct-wired connection, and wireless media such as acoustic, radio frequency (RF), infrared and other wireless media of the communication system. The computing device 2250 may include a network interface card 2268 to connect (wired or wireless) to a network.

Computer program code for carrying out operations described above may be written in a variety of programming languages, including but not limited to a high-level programming language, such as Python, Java, Javascript, C#, C or C++, for development convenience. In addition, computer program code for carrying out operations of embodiments described herein may also be written in other programming languages, such as, but not limited to, interpreted languages. The program code may include hardware description language (HDL) or very high speed integrated circuit (VHSIC) hardware description language, such as for firmware programming. Some modules or routines may be written in assembly language or even micro-code to enhance performance and/or memory usage. It will be further appreciated that the functionality of any or all of the program modules may also be implemented using hardware, software, firmware, or a combination thereof. For example, the program modules may be implemented using discrete hardware components, one or more application specific integrated circuits (ASICs), or a programmed Digital Signal Processor (DSP) or microcontroller. A code in which programming instructions of the embodiments are described can be included as a firmware in a RAM, a ROM, and a flash memory. Otherwise, the code can be stored in a non-transitory, tangible computer-readable storage medium such as a magnetic tape, a flexible disc, a hard disc, a compact disc, a photo-magnetic disc, a digital versatile disc (DVD) or the like and subsequently executed by the one or more processors.

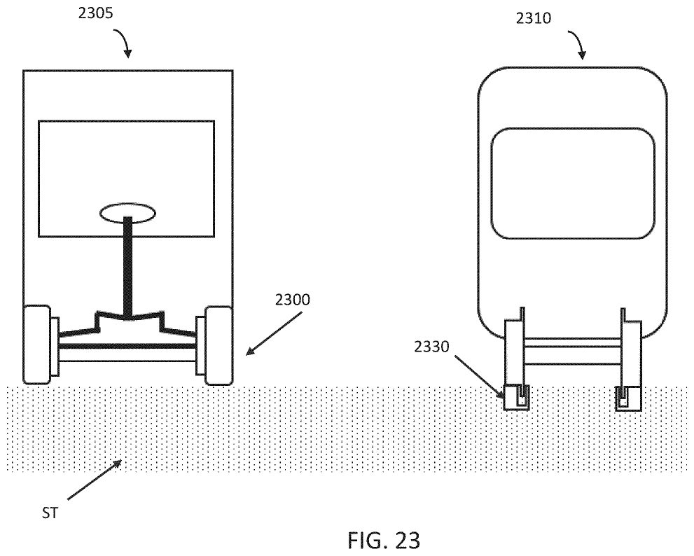

FIGS. 23, 24, 25A and 25B illustrate various examples of a vehicle driving along a surface of a street, a trough rail track or rail track. The illustrations show a pair of front dual wheel assemblies 2300, 2400 or 2500.

FIG. 23 illustrates route sharing between a streetcar 2310 and vehicle 2305 with the vehicle 2305 driving on a surface of a road or street ST. The vehicle 2305 includes a pair of front dual wheel assemblies 2300 (i.e., front dual wheel assembly 1100A or 1500). The vehicle 2305 may use traditional roads and streets when necessary, such as when the rail tracks are not available. The streetcar 2310 is shown being propelled along a streetcar rail track 2330.

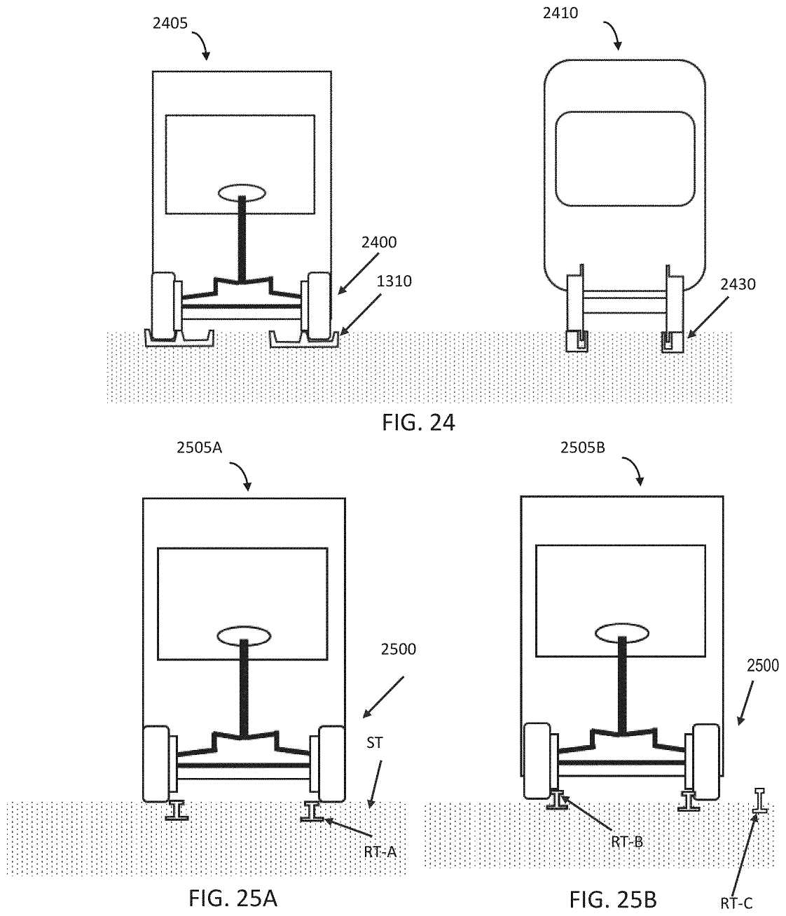

FIG. 24 illustrates route sharing between a streetcar 2410 using streetcar rail tracks 2430 and vehicle 2405 driving using a trough rail track 1310. The vehicle 2405 includes a pair of front dual wheel assemblies 2400 (i.e., front dual wheel assembly 1100A or 1500).

FIG. 25A illustrates a vehicle 2505A driving on the road or street ST having a rail track RT-A in a recessed position in the road. In some embodiments, the hybrid track and wheel system may include wheel assemblies 2500 and retractable rail track RT-A. Other wheel assemblies may be included such as rear wheel assemblies shown in FIGS. 12A and 14A.

FIG. 25B illustrates a vehicle 2505B driving on the rail track RT-B in a raised position. The vehicles 2505A and 2505B include a pair of front dual wheel assemblies 2500 (i.e., front dual wheel assembly 1100A or 1500). In some embodiments, vehicle 2505B may include other wheel assemblies such as rear wheel assemblies shown in FIGS. 12A and 14A.

In some embodiments, an existing rail track system may include two rail tracks, such as rail tracks RT-A and RT-C, rail tracks RT-A and RT-B or rail tracks RT-B and RT-C. The existing rail track system may be modified to include three rail tracks RT-A, RT-B and RT-C such that at least one of the rail tracks RT-A, RT-B and RT-C may be retractable so as not to interfere with the vehicle or train when rolled therealong. For example, in some embodiments, rail track RT-B may be added to accommodate the spacing between rail wheels of a vehicle or truck, which may be different from the spacing of rail wheels of a train or streetcar. In other embodiments, the rail wheels of a vehicle may have a spacing to fit on an existing rail track system.

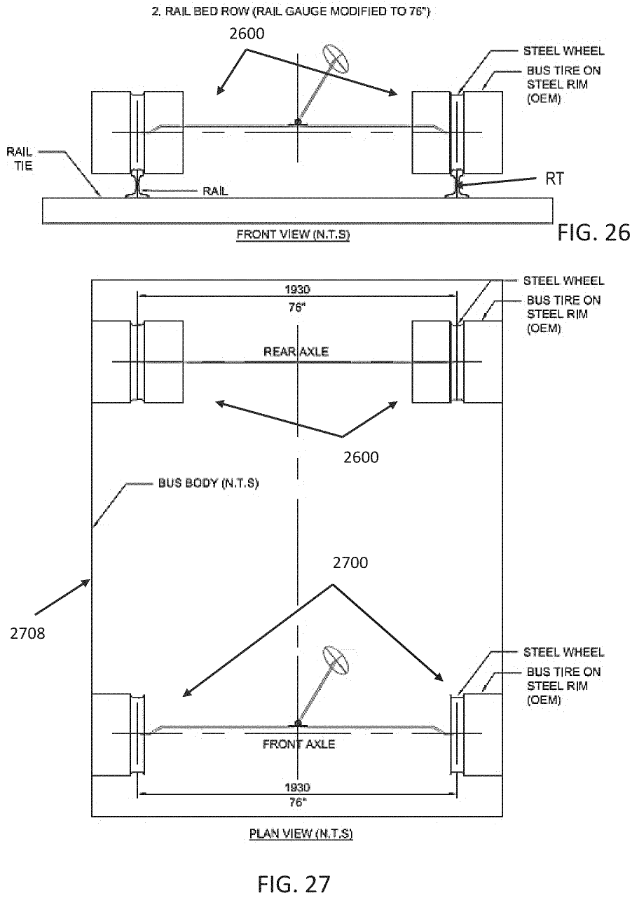

FIG. 26 illustrates a front view of a pair of rear triple wheel assemblies 2600 (i.e., rear triple wheel assemblies 1200A) on a rail track RT.

FIG. 27 illustrates a plan view of a vehicle bed 2708 with a pair of front dual wheel assemblies 2700 (i.e., front dual wheel assembly 1100A or 1500) and a pair of rear triple wheel assemblies 2600 aligned with the front dual wheel assemblies.

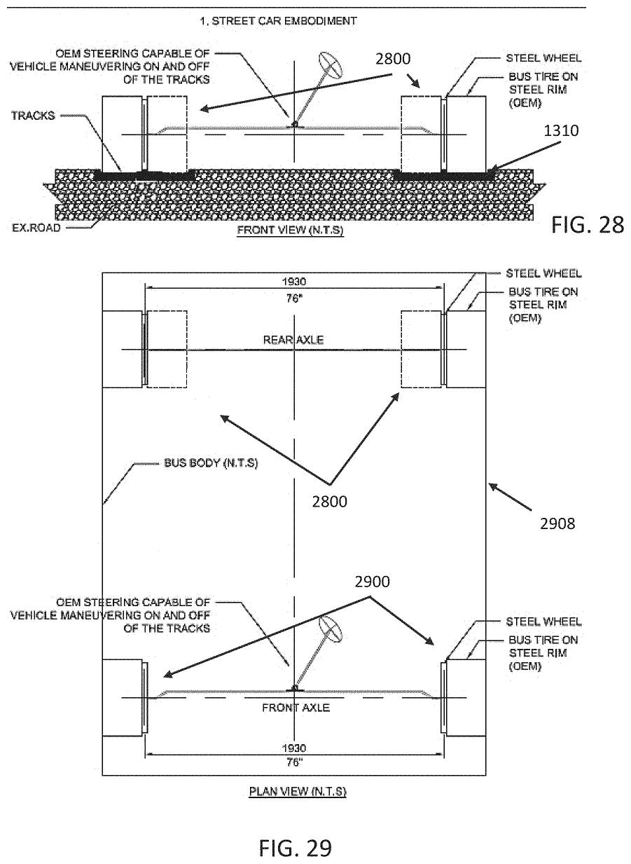

FIG. 28 illustrates a front view of a pair of rear triple wheel assemblies 2800 (i.e., rear triple wheel assemblies 1200A) in a trough rail track 1310.

FIG. 29 illustrates a plan view of a vehicle bed 2908 with a pair of front dual wheel assemblies 2900 (i.e., front dual wheel assembly 1100A or 1500) and a pair of rear triple wheel assemblies 2800 aligned with the front dual wheel assemblies.

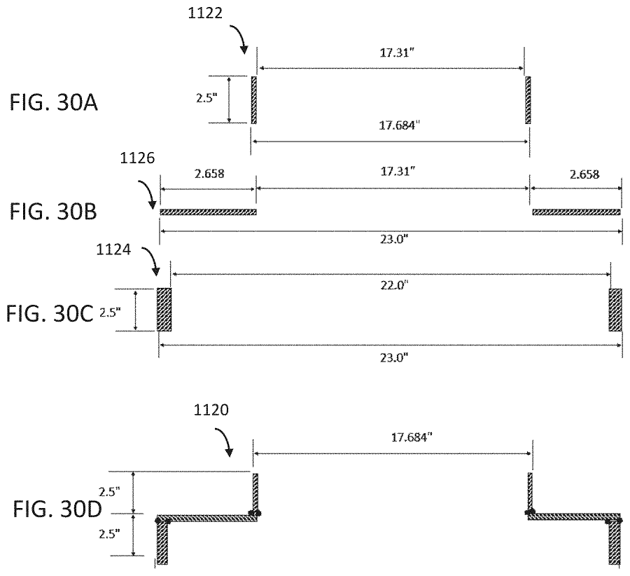

FIG. 30A illustrates a cross-sectional view of an inner hoop 1122 of the rail wheel.

FIG. 30B illustrates a cross-sectional view of a ring 1126 of the rail wheel.

FIG. 30C illustrates a cross-sectional view of an outer hoop 1124 of the rail wheel.

FIG. 30D illustrates a cross-sectional view of the rail wheel 1120.

In view of the foregoing, the embodiments include a dual wheel assembly having a hub body. The hub body includes a central disc having a plurality of apertures to connect to bolts of the vehicle; a tire rim having an outboard flange, an inboard flange and a drop center between the outboard flange and the inboard flange; and a rail wheel integrated with at least one of the central disc and tire rim.

In some embodiments, the rail wheel is permanently affixed to the inboard flange.

The rail wheel includes a wheel ring having an inner circle edge and an outer circle edge; an inner hoop connected to the tire rim and the inner circle edge; and an outer hoop configured to engage a rail track and connected to the outer circle edge.

In some embodiments, the rail wheel includes a vibration dampening ring; an inner hoop connected to the tire rim and the vibration dampening ring; and an outer hoop configured to engage a rail track and connected to the vibration dampening ring.

In some embodiments, a triple wheel assembly includes a first hub body including a first central hub having a plurality of apertures to connect to bolts of the vehicle, and a first tire rim having an outboard flange, an inboard flange and a drop center between the outboard flange and the inboard flange. The triple wheel hub assembly includes a second hub body including a second central hub having a plurality of apertures to connect to the bolts of the vehicle, and a second tire rim having an outboard flange, an inboard flange and a drop center between the outboard flange and the inboard flange; a rail wheel including a central disc having a plurality of apertures to connect to the bolts of the vehicle and an outer hoop affixed to a perimeter of the central disc. The triple wheel hub assembly may include a spacer configured to align the rear rail wheel with a front rail wheel of the vehicle.

In some embodiments, the vehicle includes a pair of front dual wheel hubs and a pair of rear triple wheel hubs and spacers, each spacer configured to align a rear rail wheel with a front rail wheel of the vehicle.

The vehicle may further include a steering controller; steering control sensors; and an image capture devices for autonomous operation on the road and on the rail track.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

What is claimed is:

1. A dual wheel assembly, comprising:
a hub body including:
a central hub having a plurality of apertures to connect to bolts of a vehicle;
a tire rim integrated with the central hub and having an outboard flange, an inboard flange and a drop center between the outboard flange and the inboard flange; and
a rail wheel integrated with at least one of the central hub and tire rim.

2. The dual wheel assembly of claim 1, wherein the rail wheel is permanently affixed to the inboard flange.

3. The dual wheel assembly of claim 1, wherein the rail wheel comprises:
a wheel ring having an inner circle edge and an outer circle edge;
an inner hoop connected to the tire rim and the inner circle edge; and
an outer hoop configured to engage a rail track and connected to the outer circle edge.

4. The dual wheel assembly of claim 1, wherein the rail wheel comprises:
a vibration dampening ring;
an inner hoop connected to the tire rim and the vibration dampening ring; and
an outer hoop configured to engage a rail track and connected to the vibration dampening ring.

5. The dual wheel assembly of claim 4, wherein the vibration dampening ring comprises a lattice structure between the inner loop and the outer loop.

6. The dual wheel assembly of claim 1, further comprising a tire configured to mount to the tire rim,
wherein a diameter of the tire is greater than a diameter of the rail wheel.

7. The dual wheel assembly of claim 1, wherein central hub is configured to be mounted to one of a front wheel axle of a vehicle and a rear wheel axle of the vehicle.

8. A triple wheel assembly for a vehicle, the triple wheel assembly comprising:
a first hub body including:
a first central hub having a plurality of apertures to connect to bolts of the vehicle, and
a first tire rim integrated with the first central hub having an outboard flange, an inboard flange and a drop center between the outboard flange and the inboard flange;
a second hub body including:
a second central hub having a plurality of apertures to connect to the bolts of the vehicle, and
a second tire rim having an outboard flange, an inboard flange and a drop center between the outboard flange and the inboard flange; and
a rail wheel including a central disc having a plurality of apertures to connect to the bolts of the vehicle and between the first central hub and the second central hub and an outer hoop affixed to a perimeter of the central disc.

9. The triple wheel assembly of claim 8, further comprising a spacer configured to align the rail wheel with another rail wheel of the vehicle.

10. The triple wheel assembly of claim 8, further comprising:
a first tire mounted to the first tire rim; and
a second tire mounted to the second tire rim.

11. The triple wheel assembly of claim 8, wherein the central disc comprises:
a vibration dampening ring.

12. The triple wheel assembly of claim 8, wherein first and second central hub bodies and rail wheel are configured to be mounted to one of a front wheel axle and a rear wheel axle of the vehicle.

13. A vehicle having a plurality of bolts, the vehicle comprising:
a pair of dual wheel assemblies, each dual wheel assembly comprising:
a hub body including:
a central hub having a plurality of apertures to connect to first bolts the plurality of bolts,
a tire rim integrated with the central hub and having an outboard flange, an inboard flange and a drop center between the outboard flange and the inboard flange, and
a first rail wheel integrated with at least one of the central hub and tire rim;
a pair of triple wheel assemblies, each triple wheel assembly comprising:
a first hub body including:
a first central hub having a plurality of apertures to connect to second bolts of the plurality of bolts, and
a first tire rim integrated with the first central hub having an outboard flange, an inboard flange and a drop center between the outboard flange and the inboard flange;
a second hub body including:
a second central hub having a plurality of apertures to connect to the second bolts, and
a second tire rim having an outboard flange, an inboard flange and a drop center between the outboard flange and the inboard flange; and
a second rail wheel including a central disc having a plurality of apertures to connect to the second bolts and between the first central hub and the second central hub and an outer hoop affixed to a perimeter of the central disc.

14. The vehicle of claim 13, wherein the first rail wheel is permanently affixed to the inboard flange.

15. The vehicle of claim 13, wherein the first rail wheel comprises:
a wheel ring having an inner circle edge and an outer circle edge;
an inner hoop connected to the inner circle edge; and
an outer hoop configured to engage a rail track and connected to the outer circle edge.

16. The vehicle of claim 13, wherein the first rail wheel comprises:
a vibration dampening ring;
an inner hoop connected to the vibration dampening ring; and
an outer hoop configured to engage a rail track and connected to the vibration dampening ring.

17. The vehicle of claim 16, wherein the vibration dampening ring comprises a lattice structure between the inner loop and the outer loop.

18. The vehicle of claim 13, further comprising servo motors coupled to first rail wheel and the second rail wheel, the servo motors are configured to adjust an alignment of the first rail wheel and the second rail wheel.

19. The vehicle of claim 13, further comprising at least one processor configured to drive the vehicle in an autonomous mode, in the autonomous mode, the at least one processor configured to align the first and second rail wheels on a rail track.

20. The vehicle of claim 13, wherein the at least one processor configured to:
detect an onramp on the rail track;
cause the vehicle to enter a path of the rail track using the detected onramp;
drive the vehicle in a platoon mode along the rail track;
determine an offramp on the rail track; and
cause the vehicle to depart the path of the rail track using the detected offramp.
